(19) United States
(12) Patent Application Publication
(10) Pub. No.: US 2026/0112995 A1
(43) Pub. Date: Apr. 23, 2026

(54) MECHANICAL PANEL INTERFACE

(71) Applicant: DS2.0, LLC, Portland, TN (US)

(72) Inventors: Dean Solon, Gallatin, TN (US); Itai Suez, Castalian Springs, TN (US); Dorothy Lou Michael, Greenbrier, TN (US)

(21) Appl. No.: 19/358,942

(22) Filed: Oct. 15, 2025

Related U.S. Application Data
(60) Provisional application No. 63/709,159, filed on Oct. 18, 2024.

(51) Int. Cl. H02S 30/10

(52) U.S. Cl. CPC H02S 30/10

(57) ABSTRACT

Systems, devices, methods, and apparatus for a mechanical panel interface. Some systems include a base member at a bottom of a module frame. At least one support member of the module frame extends vertically away from the base member. A module receiving void of the module frame is configured to receive an edge of a PV module, is located above the at least one support member, and has an opening on a same side of the PV module frame as the at least one support member. A bracket interface of the module frame has an opening located on an opposite side of the module frame than the module receiving void. The bracket interface can be configured to receive, within a perimeter of the module frame, a tab of a corresponding module bracket. At least one enclosed area of the module frame is located above or below the bracket interface.

### CROSS-REFERENCE TO RELATED APPLICATION

This application claims priority to U.S. Provisional Application No. 63/709,159, filed on Oct. 18, 2024. The disclosure of the prior application is considered part of and is incorporated by reference in the disclosure of this application.

### BACKGROUND

In solar power generation plants, solar photovoltaic (PV) modules (also referred to as solar PV panels) are mounted to racking structures by way of an interface between a PV module frame that is affixed to, or part of, the PV module and a bracket or rail that is attached to a sub-structure. On solar tracking racking systems, the substructure to which the brackets or rails are attached is called a torque tube. In existing racking systems, multiple nuts, bolts, or other fasteners are used to make the connection between the module frame and the bracket.

### SUMMARY

The present disclosure involves systems, devices, methods and apparatus for affixing a PV panel to a torque tube or other sub-structure in a “snap and play” fashion. In other words, a PV module frame, which is a component of a solar panel construction assembly is configured to interface with a bracket or rail of a torque tube or other sub-structure in a way such that the module frame snaps into place, and becomes secured to the bracket both mechanically and electrically. In this way, installation of the PV panel onto a torque tube or other sub-structure can be performed without tools, and without necessitating multiple nuts, bolts, or other fasteners. Furthermore, the connection between the module frame and the bracket or rail can be implemented to provide a reliable electrical ground connection, thereby grounding the solar module through the mechanical connection between the module frame and the bracket or rail of the torque tube or other sub-structure. For example, the frames discussed herein can be fabricated from a conductive material, such as aluminum, steel, copper, or another appropriate conductive material. In this way, the module frame can be electrically (and physically) connected to the bracket, which can in turn, be electrically and physically connected to a torque tube (or another conductive support structure), which is typically electrically grounded. In this way, a ground connection can be made to the PV module by way of the physical connection between the PV module, the module frame, the bracket, and the torque tube. This eliminates the need for additional grounding lugs or other grounding hardware.

In general, one innovative aspect of the subject matter described in this specification can be embodied in one or more components of a PV module frame system. The PV module frame system can include a base member at a bottom of a module frame, wherein the base member defines a horizontal axis; at least one support member of the module frame extending vertically away from the horizontal axis defined by the base member; a module receiving void of the module frame, wherein the module receiving void is configured to receive an edge of a PV module, wherein the module receiving void is located above the at least one support member, and has an opening on a same side of the PV module frame as the at least one support member; a bracket interface of the module frame, wherein the bracket interface has an opening located on an opposite side of the module frame than the module receiving void, wherein the bracket interface is configured to receive, within a perimeter of the module frame, a tab of a corresponding module bracket; and at least one enclosed area of the module frame located above or below the bracket interface.

These and other embodiments can each optionally include one or more of the following features. The system can include the corresponding module bracket. The corresponding bracket can be configured to connect to a support structure of a PV system. The support structure can include a torque tube.

The bracket interface can have an interior surface in a hexagon shape. At least a portion of one edge of the hexagon can be missing, thereby defining the opening of the bracket interface. The at least one enclosed area of the module frame can be located above or below the bracket interface can include at least two enclosed areas of the module frame. One of the enclosed areas can be located above the bracket interface and a separate different enclosed area can be located below the bracket interface. The bracket interface can include a leg that extends inward from an inner wall of the bracket interface. The leg can be located below the opening of the bracket interface and extend in a direction of the base member. The leg can be located above the opening of the bracket interface and extends in a direction away from the base member.

The system can include the corresponding module bracket. The corresponding module bracket can include a base surface; two side walls located on opposite sides of a centerline axis of the corresponding module bracket and extending in a same direction; two support surfaces each extending inward toward the centerline axis; two tab connection members, wherein each of the two tab connection members is respectively attached to one of the two support surfaces; two tabs extending from the two tab connection members.

The two tabs can include a first tab that extends horizontally away from the centerline axis; and a second tab that extends away from the centerline axis and extends away from the two support surfaces. The first tab can include a securing section that extends in a direction that is back toward one of the two support surface and away from the centerline axis. The second tab can include a tab extension that extends further away from the support surface and at a different angle than the location of the second tab at which the tab extension originates. the tab extension is a vertical tab extension. At least one of the first tab or the second tab can be configured to interface with the backet interface.

The system can include a second module frame having a second bracket interface that is configured differently than the bracket interface; and a PV module. The module frame and the second module frame can be connected at opposite edges of the PV module. The connection between the PV module and each of (i) the module frame and (ii) the second module frame can include both of a physical connection and an electrical ground connection.

The module frame and the second module frame can be respectively connected to two different module brackets to create an interlocking connection between (i) the module frame and a first module bracket and (ii) the second module frame and a second module bracket. The module frame and the second module frame can be fabricated from a conductive material. At least one of the module frame or the second module frame snaps into at least one of the module bracket or the second module bracket.

In general, another innovative aspect of the subject matter described in this specification can be embodied in a method including the operations of forming a base member as a bottom of a module frame, wherein the base member defines a horizontal axis; forming at least one support member of the module frame extending vertically away from the horizontal axis defined by the base member; forming a module receiving void of the module frame, wherein the module receiving void is configured to receive an edge of a PV module, wherein the module receiving void is located above the at least one support member, and has an opening on a same side of the PV module frame as the at least one support member; forming a bracket interface of the module frame, wherein the bracket interface has an opening located on an opposite side of the module frame than the module receiving void, and wherein the bracket interface is configured to receive, within a perimeter of the module frame, a tab of a corresponding module bracket; and forming at least one enclosed area of the module frame located above or below the bracket interface.

The details of these and other aspects and embodiments of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is an illustration of a system in which PV module frames are affixed to, or otherwise interface with, brackets.

FIG. 1B is an isolated view of a frame.

FIG. 2A shows a different configuration of frames.

FIG. 2B is an isolated illustration of a frame.

FIG. 2C is an isolated illustration of a frame.

FIG. 3A is an illustration of an example bracket.

FIG. 3B is an illustration of another bracket.

FIG. 4 is a flow chart of an example process for forming a PV module frame system.

FIG. 5 is an illustration of frames installed on a PV module.

FIG. 6 is an illustration of frames and installed on the PV module.

Like reference numbers and designations in the various drawings indicate like elements.

### DETAILED DESCRIPTION

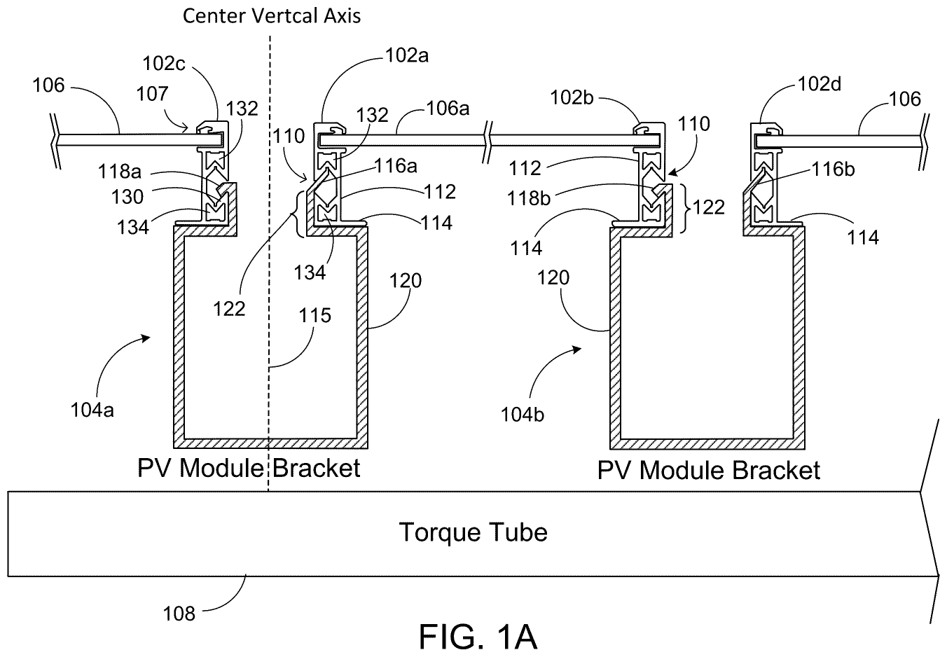

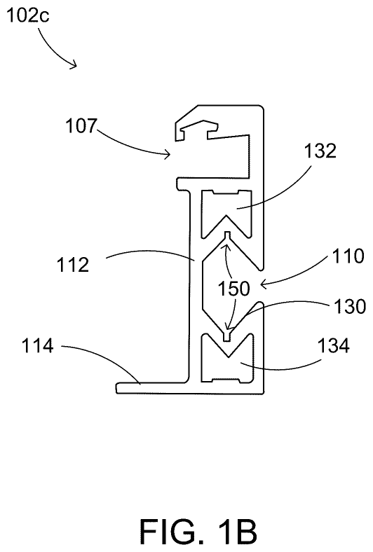

FIG. 1A is an illustration of a system 100 in which PV module frames 102 are affixed to, or otherwise interface with, brackets 104. Each section of module frame 102 is part of, or connected to, a corresponding PV module 106. Each module frame 102 is shown as being interlocked with (or connected to) a corresponding bracket 104, thereby securing the PV modules to the brackets 104a and 104b (collectively or generally referred to as brackets 104). The brackets 104 can be connected to a torque tube 108, using one of various different connection methods. For example, the brackets 104 can be connected to the torque tube 108 using a U-shaped band or strap, which is affixed to the bottom of the brackets 104, or another part of the brackets 104. As shown, each module frame 102 has a bracket interface 110 (e.g., an opening) that enables a portion of a bracket 104 to be inserted into an inner portion of the module frame 102.

With reference to PV module 106a, the frame 102a is at a left side of the PV module 106a, while a second frame 102b is at a right side of the PV module 106a. Each of these frames 102a and 102b extends away from a backside/bottom surface of the PV module 106a, and can be electrically coupled to a grounding interface of the PV module 106a. Each frame 102a, 102b (collectively or generally referred to as frames 102) has a partially enclosed area, which can have a “C” or “U” shaped portion, that wraps around an edge of the PV module 106a. In other words, each of the frames 102 has a module receiving void 107 that accepts an edge of a PV module within an inner portion of the frame 102. Each frame 102a, 102b has a support member 112 that extends away from the PV module 106a, and provides structural support between a base member 114 and the “C” shaped portion of the frame 102a (e.g., the module receiving void 107). In some implementations, the support member 112 extends vertically away from a horizontal axis defined by the base member 114. The base member 114 is shown as orthogonal to the support member 112, but could have different orientations relative to the base member 114. Each base member 114 is configured to interface with a bracket 104, and support the weight of a PV module 106 to which the frame 102 is attached. The module receiving void 107 is depicted as being above the support member 112 and having an opening on a same side of the frame 102 as the support member 112.

In some implementations, the base members 114 do not include any holes because the frames 102 are secured to the brackets by way of the integral (e.g., interlocking) designs of frames 102 and tabs of the brackets 104 discussed below. Furthermore, because the interface between the frames (which can be made of a conductive material) and the brackets 104 (which can also be made of conductive material), the physical connection between the frames 102 and the brackets 104 creates an electrical connection between the PV modules 106 and ground by way of the connections of the components and the grounded torque tube.

Each frame 102 has its bracket interface 110 oriented on an opposite side of the frame 102 than the support member 112, and the opening of the “C” shape (e.g., the module receiving void 107) that is at (or more proximate to) an opposite end of the frame 104 relative to the base member 114. The bracket interface 110 can be implemented to include an opening in which “tabs” of the brackets 104 can be located when the frame 102 is secured to the brackets 104. The opening of the bracket interface 110 can be on an opposite side of the frame 102 than the module receiving void 107).

As shown, a first tab 116a of the bracket 104a is located within the perimeter of the frame 102a, and a second tab 118a of the bracket 104a is located within the perimeter of the frame 102c. Similarly, one tab 116b of the bracket 104b is located within the perimeter of the frame 102d, and another tab 118b of the bracket 104b is located within the perimeter of the frame 102b.

To facilitate a snap on/snap in connection between the frames 102a and 102b connected to the PV module 106a and the brackets 104a and 104b, the first tab 116a can be inserted into the bracket interface 110 of the frame 102a (e.g., with the PV module 106a at an angle with the right side higher to facilitate insertion). The right side of the PV module 106a can then be lowered until the frame 102b contacts the second tab 118b of the bracket 104b. Sufficient pressure (e.g., downward pressure) can then be applied to the frame 102b to snap the second tab 118b into the bracket interface 110 of the frame 102b via spring force.

As shown, the tabs 116 are longer, and at a different angle, than the second tabs 118. For example, the length of the tabs 116 extends up and away from a center (e.g., a center vertical axis illustrated by the dashed line 115 of the main body 120 of the bracket 104. The angle of the first tab 116 coincides with (e.g., matches or is complementary to) an angle of the interior surface of the bracket interface 110. In this way, the top surface of the tab 116 is configured to interface (e.g., engage) with an interior surface of the bracket interface 110 when the PV module 106 is secured to the brackets 104.

The tab 118 extends away from the center (e.g., the center vertical axis 115) of the main body 120 of the bracket 104 in an opposite direction than the tab 116, and is shorter than the tab 116. The tab 118 has a hook shape (or J shape), such that the tab 118 can secure to a bottom lip 130 of the bracket interface 110 when the frame 102 is pressed down on the tab 118 of the bracket 104.

Each frame 102 can include at least one enclosed area that is located above and/or below the bracket interface 110. For example, the frames 102 depicted in FIG. 1A, each have two enclosed areas 132 and 134, which are respectively located above and below the bracket interface 110. These enclosed areas 132 and 134 are enclosed in that there is not an opening on all sides of the perimeter (e.g., top, bottom, and two sides) defining the enclosed areas 132 and 134. As shown, the enclosed areas 132 and 134 are not fully enclosed in that the fronts and backs of the enclosed areas are open. As such, the enclosed areas 132 and 134 need not be fully enclosed to be considered enclosed. Rather, the enclosed areas 132 and 134 are considered enclosed when at least 4 connected edges create an enclosed perimeter around the enclosed areas 132 and 134. Of course, the enclosed areas 132 and 134 could be completely enclosed, and thereby inaccessible.

Each bracket 104 includes a main body 120, which as shown is generally rectangular (or square) in shape. Each of the tabs 116 and 118 on a given bracket 104 is connected to the main body 120 by way of a tab connection member 122. The tab connection members 122 extend away from a top surface of the main body 120 (e.g., orthogonally) to provide distal separation between the main body 120 of the bracket 104 and the top points of each of the tabs 116 and 118. The length of each tab connection member 122 is selected to so that the tabs 116 and 118 will be located within the bracket interfaces 110 of the frames 102 when the frames are pushed down onto the brackets 104. Each bracket 104 has a bottom surface that is configured to interface with the torque tube 108. For example, the bottom surface of each bracket 104 depicted has a flat bottom surface that is configured to interface with a flat surface of a rectangular torque tube 108. The bottom surface of the brackets 104 can have other shapes depending on the shape of the torque tube 108 or other sub-structure to be used. For example, if the torque tube 108 was cylindrical, the bottom surface of the brackets 104 could be curved so that the bottom surface of the brackets would engage a larger surface area of the cylindrical torque tube than the flat bottomed bracket 104 shown in FIG. 1A.

The tab connection members 122, the first tab 116, and the second tab 118, are each located on an opposite side of the bracket 104 relative to the bottom surface of the bracket 104. In this way, the bracket 104 provides distal separation between the torque tube 108 and the PV module 106 that is installed on the bracket 104 using the frames 102.

The bracket interfaces 110 of the frames 102 are shown as having an interior surface having a hexagon shape, with one edge (or at least a portion of one edge) of the hexagon missing. The missing edge of the hexagon shape provides the opening of (or entry into) the bracket interface 110. As shown, the entry to the bracket interface is located on an opposite side of the frame 102 than the module receiving void. The inner surface of the bracket interface 110 that extends between a top of the opening and the top interior point of the hexagon provides a surface the tab 116 engages with. The inner surface that extends between a bottom of the opening of the bracket interface 110 and the bottom interior point of the hexagon provides a surface the tab 118 interfaces with to lock the PV module 106 in place, e.g., by way of the frames 102.

FIG. 1B is an isolated view of the frame 102c. The descriptions of the components 107, 110, 112, 114, 130, 132, and 134 are discussed above. This view of the frame 102c shows details of inner notches 150 that are included in inner perimeter of the bracket interface 110. Specifically, one of the inner notches 150 is at a top point of the hexagon shape, and the other inner notch 150 is at a bottom point of the hexagon shape. One or both of the inner notches can be formed in the frame 102c. In some implementations, the notch at the top of the frame 102c locks the tab 116a of the bracket 104a into the bracket interface 110 to ensure that the frame 102c is properly positioned. The inner notches 150 are also included in each of the frames 102a, 102b and 102d of FIG. 1A.

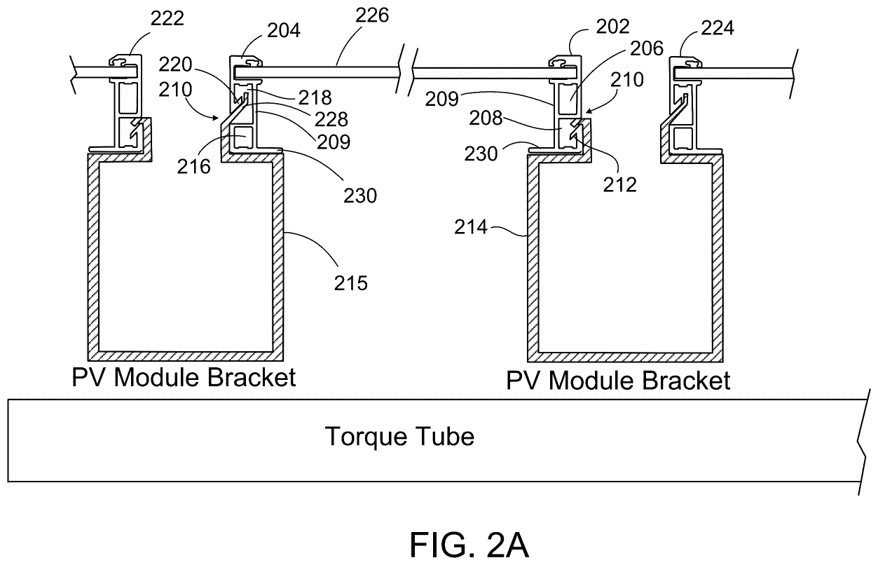

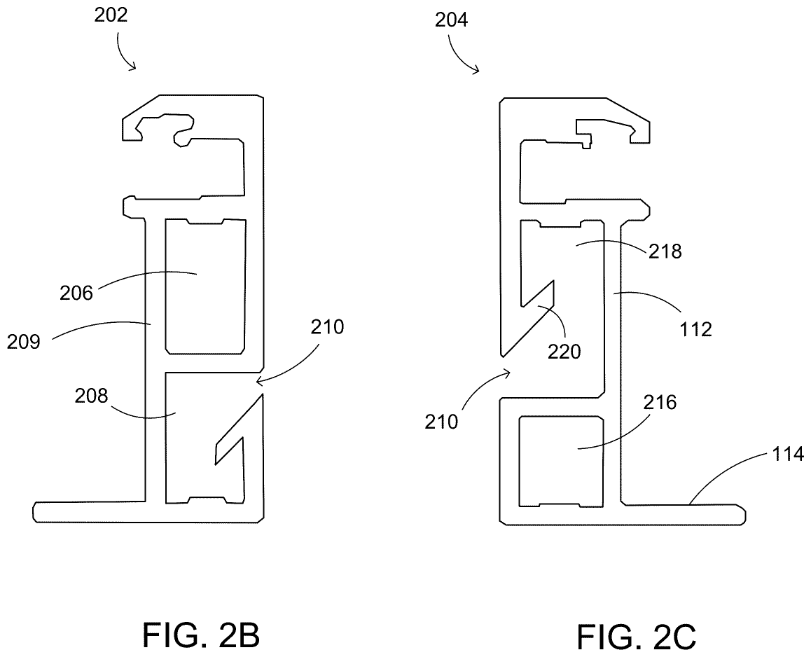

Other frame and bracket configurations are possible. For example, FIG. 2A shows a different configuration of two frames 202 and 204. The frame 202 has two rectangular interior areas 206 and 208. The area 206 is fully enclosed (e.g., doesn't have an opening in the perimeter surrounding the interior area 206), while the area 208 has an opening into a bracket interface 210. The opening into the bracket interface 210 is on an opposite side of a support member 209, which is similar to the support member 112 discussed above with reference to FIG. 1A. In this configuration, the area 208 has a leg 212 that extends down and inward from an inner wall of the area 208. This leg 212 provides a sturdy connection between the bracket 214 and the frame 202. Meanwhile, the frame 204 has two rectangular interior areas 216 and 218. The rectangular area 216 is fully enclosed (e.g., doesn't have an opening in the perimeter surrounding the interior area 216), while the rectangular area 218 has an opening in its perimeter for a bracket interface 210.

The rectangular area 218 of the frame 204 has a leg 220 that is located above the opening of the bracket interface 210, and extends up and inward from an inner wall of the area 218. This is in a direction away from a base member 230 of the frame 204. This facilitates a sturdy connection between the bracket 215 and the frame 204. For example, as shown a tab 228 of the bracket 215 is secured inside the rectangular (inner) area of the frame 204. An angled portion of the tab 228 extends into the bracket interface 210, and a vertical portion of the tab 228 extends up beyond the leg 220. In operation the vertical portion of the tab 228 can be used to guide insertion of the tab 228 into the proper location of the bracket interface 210 and/or to provide a more secure connection to the bracket 215. Note that the vertical portion of the tab 228 need not be completely vertical. In some implementations, it has a more vertical orientation than the angled portion of the tab 228.

As shown in FIG. 2A, the frame 222 has the same configuration as the frame 202 and the frame 224 has the same configuration as the frame 204. Also, the frames 202 and 204 each connect to the same PV module 226, and secure that PV module 226 to a pair of different brackets 214.

Each of the frames 202 and 204 includes a base member 230, which is similar to the base member 114 previously discussed, and will not again be discussed here.

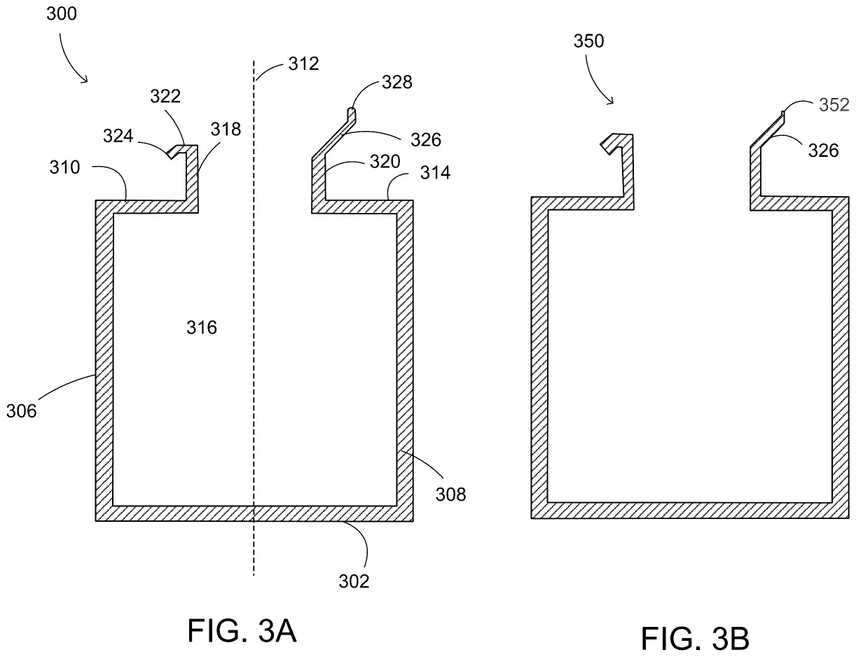

The brackets 214 and 215 have the same configuration. The brackets 214 and 215 are configured to securely interface with the frames 202, 204, 222, and 224. The configuration of the brackets 214 and 215 is similar to the configuration of the brackets 104a and 104b, but differs in some respects. The configuration of the brackets 214 and 215 is the same as the configuration of the bracket 300 discussed below with reference to FIGS. 3A and 3B.

FIG. 2B is an isolated illustration of the frame 202. The components of the frame 202 are discussed above, and therefore not repeated here.

FIG. 2C is an isolated illustration of the frame 204. The components of the frame 204 are discussed above, and therefore not repeated here.

FIG. 3A is an illustration of an example bracket 300, which is substantially the same as the bracket 215. As shown, the bracket 300 includes a base (bottom) surface 302 that is configured to interface with (e.g., engage, touch, etc.) a surface of a torque tube when installed. The bracket 300 also includes two side walls 304 and 306. These side walls 304 and 306 extend upward away from the base surface 302. In other words, the side walls 304 and 306 are not parallel with or along a same horizontal axis as the base surface 302. Rather, the side walls 304 and 306 extend in a direction that is at least partially vertically distal from the horizontal axis defined by the base surface 302.

At, or near, the distal end of the side wall 304 is a support surface 310 that extends toward a centerline axis that bisects a width of the base surface 302. The centerline axis is represented by the dashed line 312. In some implementations, the support surface does 310 not extend all the way to the centerline axis 312. For example, as shown, the support surface 310 can be shorter than one-half the base surface 302.

At the distal end of the side wall 306 is another support surface 314 that extends toward the centerline axis 312 that bisects a width of the base surface 302. In some implementations, the support surface does 314 not extend all the way to the centerline axis 312. For example, as shown, the support surface 314 can be shorter than one-half the base surface 302. Each of the support surfaces 310 and 314 are included to (and configured to) provide a surface upon which frames discussed in this specification can rest (e.g., engage, touch, be supported, etc.) when the frames are installed on the bracket 300.

In some implementations, an interior area 316 of the bracket 300 can be defined within a rectangular perimeter defined by the bottom surface 302, side walls 306 and 308, and support surfaces 310 and 314.

The bracket 300 includes a tab connection member 318 and another tab connection member 320. The tab connection member 318 extends upward and away from the support surface 310, such that the tab connection member 318 also extends away from the base surface 302. At the top end of the tab connection member 318 (or at some other location distal to the support surface 310) is a tab 322 of the bracket 300. The tab 322 is similar to (e.g., the same as) the tab 118 previously discussed. The tab 322 extends away from the centerline axis 312 of the bracket 300. As shown, the tab 322 initially extends horizontally away from the tab connection member 118 in a direction of an axis defined by the side wall 306. The tab 322 then includes a securing section 324 that extends in a direction that is back toward the support surface 310 and the axis defined by the side wall 306 (e.g., away from the centerline axis 312). This facilitates locking of a frame on the bracket 300 when the frame is pushed down onto the frame 300. That is, once the tab 322 (including the securing section 324) is forced into in alignment with a bracket interface of a frame, the tab 322 will snap into an interior of the frame perimeter, and the securing section 324 will secure the connection between the frame and the bracket 300. This functionality was previously discussed with reference to the tabs 118 of FIG. 1A. For example, as shown in FIG. 1A, when the frame 102b is forced down onto the frame 104b, the tab 118b moves into the interior of the frame 102b. Once inserted, the securing section (e.g., 324 of FIG. 3A), is engaged with an inner surface of the bracket interface 110, thereby creating a secure connection between the bracket 104b and the frame 102b.

Returning to the description of FIG. 3A, the tab connection member 320 is on an opposite side of the centerline axis 312 than the tab connection member 318. The tab connection member 320 extends upward and away from the support surface 314, such that the tab connection member 320 also extends away from the base surface 302. At the top end of the tab connection member 320 (or at some other location distal to the support surface 314) is a tab 326 of the bracket 300. The tab 326 is similar to the tab 116 previously discussed, but differs slightly as discussed below. The tab 326 is similar to the tab 116 in that it extends away from the centerline axis 312 of the bracket 300. More specifically, the tab 326 initially extends upward away from the support surface 314 (and the base surface 302), and toward a vertical axis defined by the side wall 308 (away from the centerline axis 312). The tab 326 differs from the tab 116 because the tab 326 also includes a tab extension 328 that extends further away from the support surface 314 (and the base surface 302). As shown, the tab extension 328 has a vertical orientation, but the tab extension 328 could be at a different angle (e.g., angled back toward the centerline axis 312 or toward the vertical axis defined by the side wall 308). The tab extension 328 is configured to provide an additional securing member and/or a guide for insertion of the tab 326 into a corresponding PV frame. As discussed with reference to FIG. 2A, the tab extension 328 (which corresponds to the vertical portion of the tab 228 discussed above) can be inserted into the interior of a bracket through a bracket interface, and when the tab extension 328 is fully inserted, the frame (and PV module) are then able to be rotated into position such that the tab 322 is able to be inserted into another frame, thereby securing the frame/PV module combination to the bracket 300.

FIG. 3B is an illustration of another bracket 350, which is substantially the same as the bracket 104a previously discussed. The bracket 350 is also very similar to the bracket 300 discussed above. However, rather than including the tab extension 328 at the end of the tab 326, as shown in the bracket 300, the bracket 350 has a nub 352 that is configured to interface with an inner notch 150 of a frame, such as the frame 102c of FIG. 1B. For example, the nub 352 can be guided into the upper inner notch 150 of the frame 102c to guide the positioning of the frame 102c as well as a second frame that is on another side of a PV module to which the frame 102c is connected. This facilitates a guided installation of the frames on brackets.

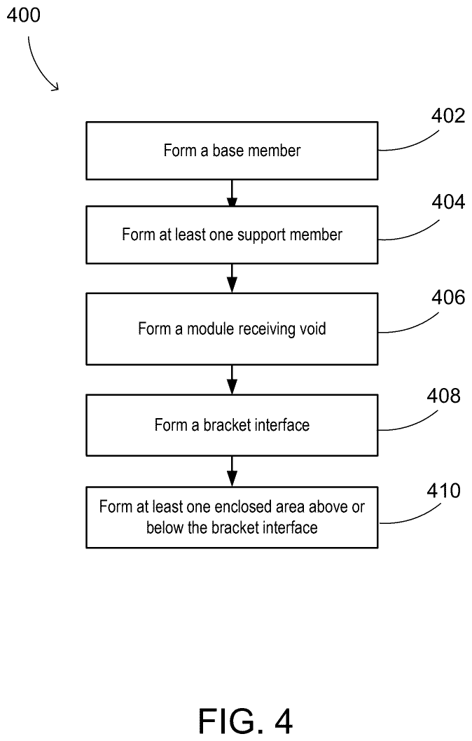

FIG. 4 is a flow chart of an example process 400 for forming a PV module frame system. Each of the components of a PV module frame can be formed from any appropriate material. For example, the brackets can be formed from metal or plastic. When the brackets are formed from metal, they can be aluminum, steel, copper, or another appropriate conductive material. The acts of forming the various components of the PV module frame system can include extrusion or other appropriate processes for forming components of a PV module frame as required to manufacture the module frames discussed throughout this document.

At step 402, a base member is formed. In some implementations, the based member is formed as a bottom of a PV module frame. The base member can define a horizontal axis, as shown with reference to the base member 114 of FIGS. 1A and 1B.

At step 404 at least one support member is formed. In some implementations, the support member of the module frame is formed to extend vertically away from the horizontal axis defined by the base member, as shown with reference to the support member 112 of FIGS. 1A and 1B.

At step 406, a module receiving void is formed (406). In some implementations, the module receiving void is formed to receive an edge of a PV module. As formed, the module receiving void can be located above the at least one support member. The module receiving void can have an opening on a same side of the PV module frame as the at least one support member. An example module receiving void, as formed, is represented by the module receiving void 107 of FIG. 1A.

At step 408, a bracket interface is formed. In some implementations, the bracket interface has an opening located on an opposite side of the module frame relative to the module receiving void, as shown with reference to the bracket interface 110 of FIG. 1A. The bracket interface can be formed to receive, within a perimeter of the module frame, a tab of a corresponding module bracket, as previously discussed. In some implementations, the bracket interface is formed to have an interior surface in a hexagon shape, and at least a portion of one edge of the hexagon is missing, thereby defining an opening of the bracket interface. In some implementations, the bracket interface includes a leg that extends inward from an inner wall of the bracket interface. In some configurations the leg is located below the opening of the bracket interface and extends in a direction of the base member. In some configurations, the leg is located above the opening of the bracket interface and extends in a direction away from the base member.

At step 410, at least one enclosed area is formed above or below the bracket interface. In some implementations, at least two enclosed areas of the module frame are formed. In these implementations, one of the enclosed areas is formed above the bracket interface and a separate different enclosed area is located below the bracket interface.

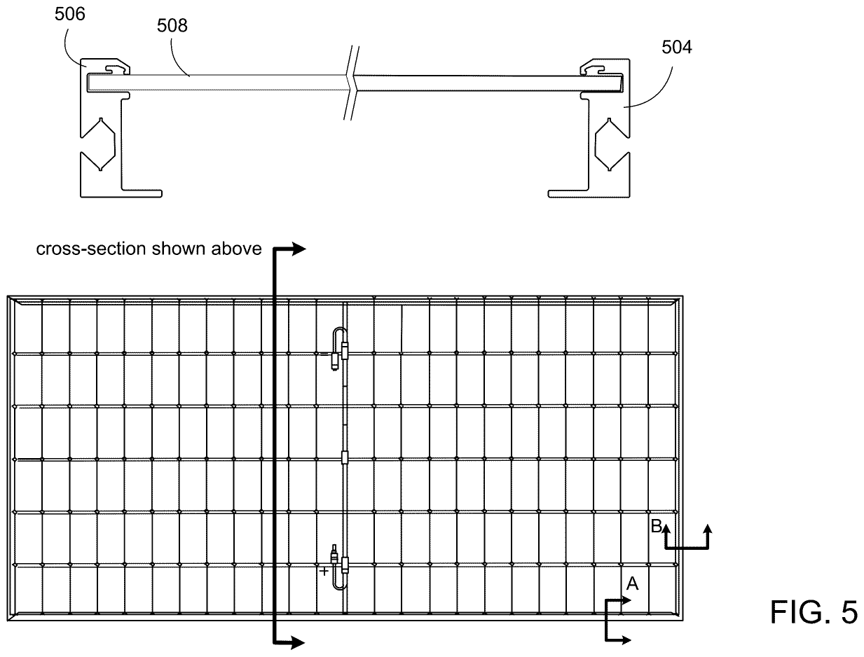

FIG. 5 is an illustration of the frames 504 and 506 installed on a PV module 508. The frames 504 and 506 have a similar shape and bracket interfaces as the frames 102a and 102b of FIG. 1A, but the frames 504 and 506 lack the openings 132 and 134. Rather, the corresponding portions of the frames 504 and 506 are solid.

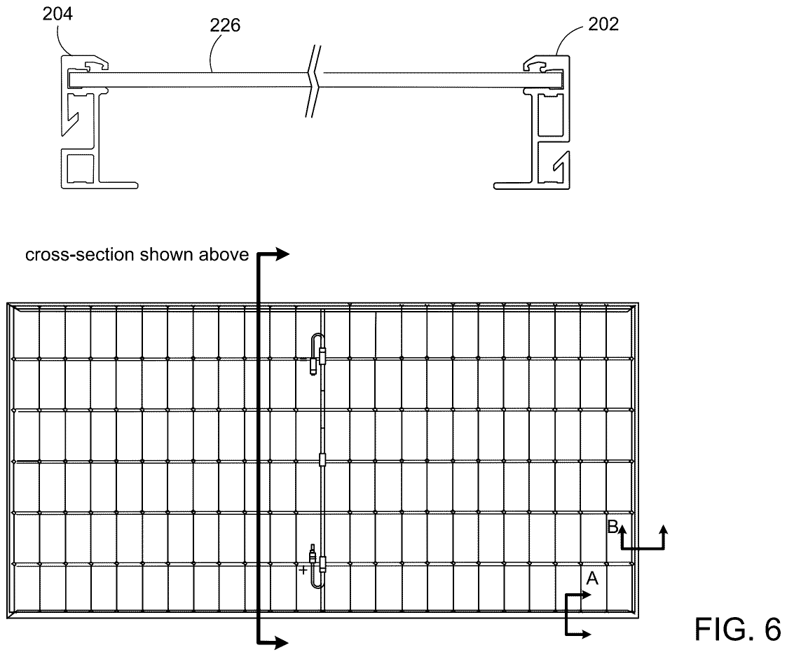

FIG. 6 is an illustration of the frames 202 and 204 installed on the PV module 226.

For purposes of this specification, the bottom of the frames 102, 202, 204 or any other frame discussed herein refers to a surface of the frame that engages (e.g., touches), or is oriented toward (proximate to or most proximate to) a surface of the bracket when installed. Meanwhile, the top of any of the frames refers to a surface of the frame that is distal (e.g., most distally located) relative to the bottom of the frame.

Each of the frames, brackets, and torque tubes discussed herein can be fabricated using a conductive material (e.g., aluminum, steel, copper, or another appropriate conductive material). Furthermore, the frames discussed herein can be electrically connected to equipment grounding of the PV modules to which they are connected, which can be carried out during manufacturing of the PV module, or after manufacturing the PV module. In this way, a connection between the PV module equipment grounding of the PV module and earth ground can be facilitated by simply making the physical connections of the PV module, the frames discussed here, the brackets discussed herein, and the torque tube, which is already grounded. Thus, the physical connections between these components also constitute an electrical connection of the PV module (and the other components) to ground without requiring a separate ground connection.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A photovoltaic (PV) module frame system, comprising:
a base member at a bottom of a module frame, wherein the base member defines a horizontal axis;
at least one support member of the module frame extending vertically away from the horizontal axis defined by the base member;
a module receiving void of the module frame, wherein the module receiving void is configured to receive an edge of a PV module, wherein the module receiving void is located above the at least one support member, and has an opening on a same side of the PV module frame as the at least one support member;
a bracket interface of the module frame, wherein the bracket interface has an opening located on an opposite side of the module frame than the module receiving void, wherein the bracket interface is configured to receive, within a perimeter of the module frame, a tab of a corresponding module bracket; and
at least one enclosed area of the module frame located above or below the bracket interface.

2. The PV module system of claim 1, further comprising:
the corresponding module bracket, wherein the corresponding bracket is configured to connect to a support structure of a PV system.

3. The PV module system of claim 2, wherein the support structure comprises a torque tube.

4. The PV module system of claim 1, wherein the bracket interface has an interior surface in a hexagon shape, wherein at least a portion of one edge of the hexagon is missing, thereby defining the opening of the bracket interface.

5. The PV module system of claim 4, wherein the at least one enclosed area of the module frame located above or below the bracket interface comprises at least two enclosed areas of the module frame, wherein one of the enclosed areas is located above the bracket interface and a separate different enclosed area is located below the bracket interface.

6. The PV module system of claim 1, wherein the bracket interface includes a leg that extends inward from an inner wall of the bracket interface.

7. The PV module system of claim 5, wherein the leg is located below the opening of the bracket interface and extends in a direction of the base member.

8. The PV module system of claim 5, wherein the leg is located above the opening of the bracket interface and extends in a direction away from the base member.

9. The PV module system of claim 1, further comprising the corresponding module bracket, wherein the corresponding module bracket comprises:
a base surface;
two side walls located on opposite sides of a centerline axis of the corresponding module bracket and extending in a same direction;
two support surfaces each extending inward toward the centerline axis;
two tab connection members, wherein each of the two tab connection members is respectively attached to one of the two support surfaces;
two tabs extending from the two tab connection members.

10. The PV module system of claim 9, wherein the two tabs comprise:
a first tab that extends horizontally away from the centerline axis; and
a second tab that extends away from the centerline axis and extends away from the two support surfaces.

11. The PV module system of claim 10, wherein the first tab includes a securing section that extends in a direction that is back toward one of the two support surface and away from the centerline axis.

12. The PV module system of claim 11, wherein the second tab includes a tab extension that extends further away from the support surface and at a different angle than the location of the second tab at which the tab extension originates.

13. The PV module system of claim 12, wherein the tab extension is a vertical tab extension.

14. The PV module system of claim 12, wherein at least one of the first tab or the second tab is configured to interface with the backet interface.

15. The PV module system of claim 14, further comprising:
a second module frame having a second bracket interface that is configured differently than the bracket interface; and
a PV module, wherein the module frame and the second module frame are connected at opposite edges of the PV module.

16. The PV module system of claim 15, the connection between the PV module and each of (i) the module frame and (ii) the second module frame comprises both of a physical connection and an electrical ground connection.

17. The PV module system of claim 16, wherein the module frame and the second module frame are respectively connected to two different module brackets to create an interlocking connection between (i) the module frame and a first module bracket and (ii) the second module frame and a second module bracket.

18. The PV module system of claim 17, wherein the module frame and the second module frame are fabricated from a conductive material.

19. The PV module system of claim 18, wherein at least one of the module frame or the second module frame snaps into at least one of the module bracket or the second module bracket.

20. A method, comprising:
forming a base member as a bottom of a module frame, wherein the base member defines a horizontal axis;
forming at least one support member of the module frame extending vertically away from the horizontal axis defined by the base member;
forming a module receiving void of the module frame, wherein the module receiving void is configured to receive an edge of a PV module, wherein the module receiving void is located above the at least one support member, and has an opening on a same side of the PV module frame as the at least one support member;
forming a bracket interface of the module frame, wherein the bracket interface has an opening located on an opposite side of the module frame than the module receiving void, and wherein the bracket interface is configured to receive, within a perimeter of the module frame, a tab of a corresponding module bracket; and
forming at least one enclosed area of the module frame located above or below the bracket interface.
